(19) United States
(12) Patent Application Publication
(10) Pub. No.: US 2020/0324307 A1
(43) Pub. Date: Oct. 15, 2020

(54) System For Painting And Coating Of Substrates

(71) Applicant: Paragon Fusionclad (PPC) Ltd., Edmonton (CA)

(72) Inventors: Damon Clifford Stewart, Sherwood Park (CA); Dean Stewart Hansen, Edmonton (CA)

(21) Appl. No.: 16/848,365

(22) Filed: Apr. 14, 2020

Related U.S. Application Data
(60) Provisional application No. 62/833,901, filed on Apr. 15, 2019.

(51) Int. Cl. B05B 12/00; B05B 7/12; B05B 9/01

(52) U.S. Cl. CPC B05B 12/004; B05B 9/01; B05B 7/12

(57) ABSTRACT

A portable system is provided for use with one or more painting or coating spray guns. The system includes a system case, the case being liftable, towable and transportable by helicopter or truck. The case contains storage for one or more coating or paint cartridges, the storage being heatable to maintain cartridges at a predetermined temperature, an independent power source and an independent source of compressed air. The system is operable by a single user and usable in connection with one or more painting or coating spray guns for remote site painting and coating operations. A method of performing painting and coating operations in a remote site is also provided.

### FIELD

The present disclosure relates to an automated or semi-automated system for storage, transport and use of paints and plural component coatings.

### BACKGROUND

Spray coating or painting of pipes, pipelines and industrial equipment collectively called substrates, is required to prevent corrosion and potential damage or breach of such substrates. While some substrates are coated for use below ground, painting and coating can also be required for above grade substrates.

In above ground applications, paints such as for example urethane, enamel and epoxy based paints, are commonly applied to substrates via a nozzle using compressed air. The paints are commonly required to be kept at a minimum temperature for proper use, and in colder ambient applications may require on site heating.

The coating fluid to be applied to below ground substrates is commonly a plural component, and more commonly a dual component, 100% solids epoxy product in which the components need to be heated, combined and applied via a nozzle using compressed air.

While painting and coating of lengths of sections of pipe and parts of equipment may be done in a painting/coating facility, typically weld seams in the pipeline, as well as any parts of substrates assembled on site must be also painted or coated, at remote locations where the work is taking place. As well, in a case where a substrate is field welded or needs to be replaced or repaired, on site painting and/or coating is again required.

Traditionally, the large barrels or vats of each coating component must be transported out to site and heated by a heating line that is either electrical or a coil of heating fluid like glycol, in which case a source of glycol must also be provided on site. The heated coating components are then pumped in separate lines, with compressed air in another line. All of the lines are contained in a large hose, which ends at a nozzle end. The substrate to be coated is often not in proximity of all of the coating equipment and can be up to 200 ft away, requiring extensive hose length. To keep the coating components at the required temperature, which can range from −20° C. to 100° C., the hose also includes either an electrical or glycol heating line to the nozzle—hence 4-6 or more separate lines (component lines, heating lines, flush lines, return lines) are all contained in the hose. For cold weather applications, the hose further has to be insulated. The weight of these hoses is often such that multiple operators are required to support them. A power source or generator is also required to power pumps to pump components from vats to through the component lines, to power an air compressor to supply compressed air, and to provide heating to the vats and hose.

Until now, the equipment needed for plural component coating has been significantly large and cumbersome and is hence typically hauled on 5-10 ton trucks. The number of operators needed for an on-site painting coating job is typically 4-6. While the size of equipment and manpower requirements may be suitable for very large coating jobs, the current set up is oversized for smaller jobs such as only coating a welded pipe joint, field weld or a repaired surface of substrate.

To avoid the use of the current equipment on small repair jobs, painting or coating is performed by manual brushing, which can lead to increased application times and uneven coverage. The thickness and evenness of coverage is dictated by strict safety and industrial standards, and so a hand coating job can be labour intensive and difficult.

Some examples of prior systems include U.S. Pat. No. 6,666,301 owned by Urecoat Technologies, Inc., teaching a system mounted on a trailer of a flatbed semi-truck. It has a tank of one of the coating materials, the tank being heated by an internal heating system and a second material to be mixed with the first material in a static mixer unit. It also requires that the hose feeding the materials to the outlet valve/coupling be heated.

Another example is U.S. Pat. No. 7,963,719 to Wilson relating to a portable system for applying coating to surfaces, in which the coating materials do not require heating, so not a 100% solid component epoxy system. Very small volumes are being provided in a portable, “back-pack” style container. There is no compressor or power source provided. A further example is U.S. Pat. No. 3,841,527 to von Roeschlaub relates to an applicator for a hot product like joint sealant. The material is heated using heating coils filled with a heating material and is stored in a tank. The dispensing hose also needs to be heated.

Recently, coating spray guns have been introduced on the market for smaller jobs. Spray guns include a cartridge for each of the epoxy coating components, having a volume of from about 0.5 to 1 L each, but which can naturally vary. The spray gun can be hooked up to a source of compressed air to supply the hydraulic power needed for spraying; that is the spraying force. The cartridges of coating component must still be heated up to the required 50 to 60° C. One method presently being used, for example, is to heat the cartridges in a microwave to an approximate temperature, loading the heated cartridges into the spray gun, connect the spray gun to a compressed air source, then moving over to the substrate and applying the coating.

Units using spray guns in other industries can be seen in, for example, U.S. Pat. No. 6,533,189 owned by Vortex Spraylines, Inc. This unit is used for painting truck bed liners and is used indoors at a painting facility. It uses a spray gun, however not with cartridges but rather with traditional tanks of coating components, the tanks being heated and temperature regulated, but the lines connecting the tanks to the spray gun are not heated or insulated. A compressor mounted on the cart and connected by a line to the spray gun supplies compressed air, although there is no dedicated power source, the compressor and tank pumps can be connected to a standard power source.

However a need still exists in the plural component epoxy coating industry for a convenient means of taking advantage of the new cartridge spray guns such that they could replace the nozzle system traditionally used. The need also exists for the ability to use such spray guns in remote locations where temperatures can drop to well below 0° C. for outdoor work and for a way in which to use the spray guns such that the cartridges can replace the barrels or vats of coating components and heated, insulated hoses.

### SUMMARY

A portable system is provided for use with one or more painting or coating spray guns. The system comprises a system case, said case being liftable, towable and transportable by helicopter or truck. The case contains storage for one or more coating or paint cartridges, said storage being heatable to maintain cartridges at a predetermined temperature, an independent power source and an independent source of compressed air. The system is usable in connection with one or more painting or coating spray guns for remote site painting and coating operations.

A method of performing painting and coating operations in a remote site is provided. The method comprises the steps of transporting a case by means of truck, helicopter or towing to the remote site; providing within said case: storage for one or more coating or paint cartridges, said storage being heatable to maintain cartridges at a predetermined temperature; an independent power source; and an independent source of compressed air; connecting one or more spray guns to the source of compressed air and charging the one or more spray guns with one or more cartridges; and coating with the one or more spray guns a surface to be coated.

It is to be understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

A further, detailed, description of the invention, briefly described above, will follow by reference to the following drawings of specific embodiments of the invention. The drawings depict only typical embodiments of the invention and are therefore not to be considered limiting of its scope. In the drawings:

FIG. 1 is a first perspective view of one example of a case for use with a system of the present invention;

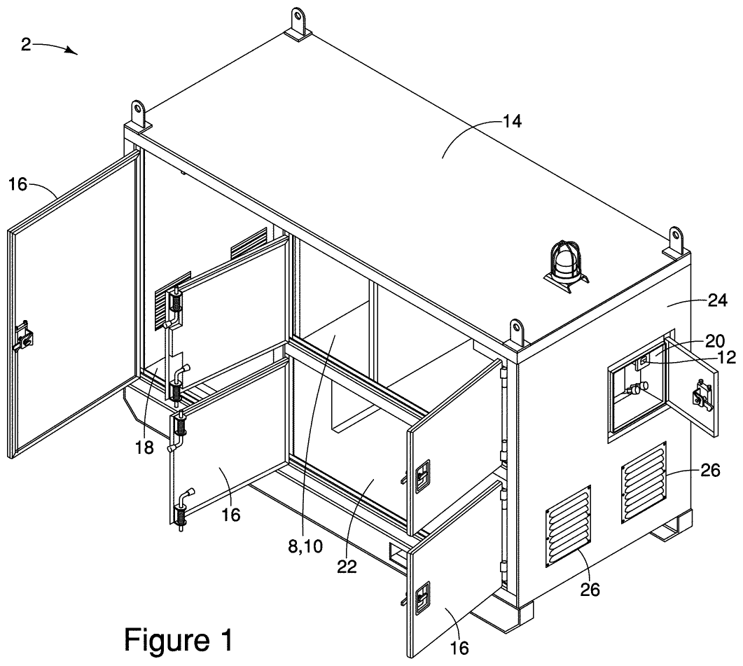

FIG. 2 is a further perspective view of the case of FIG. 1;

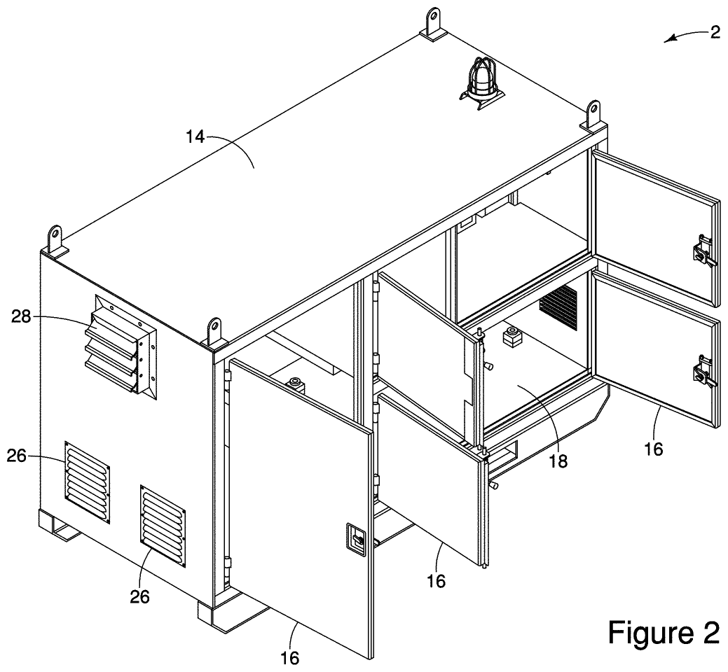

FIG. 3 is a front elevation view of one example of the system as contained in the case of FIG. 1;

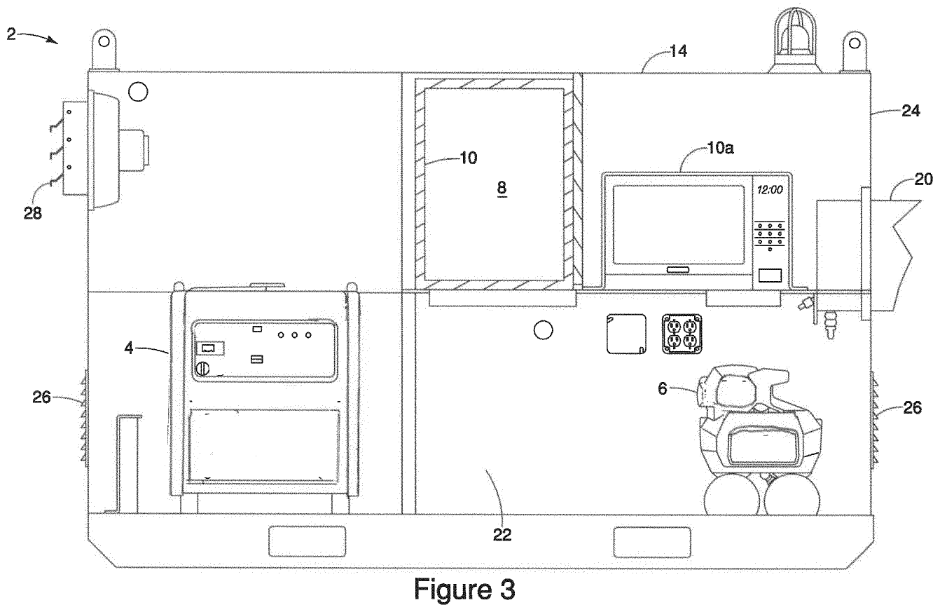

FIG. 4 is top plan view of the case of FIG. 1;

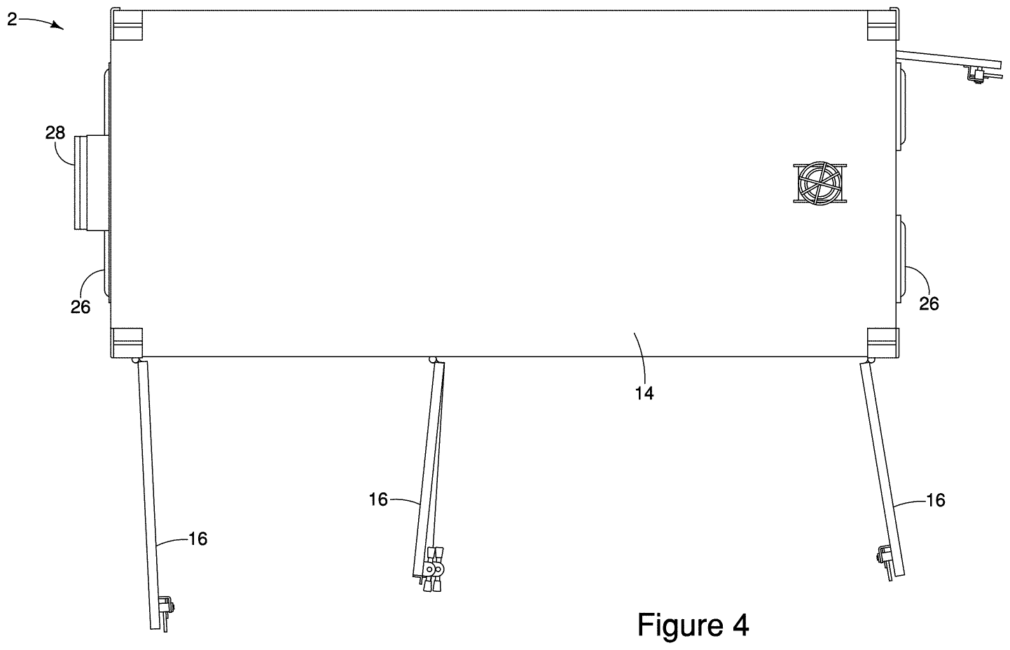

FIG. 5 is a perspective view of an interior of the system of FIG. 3; and

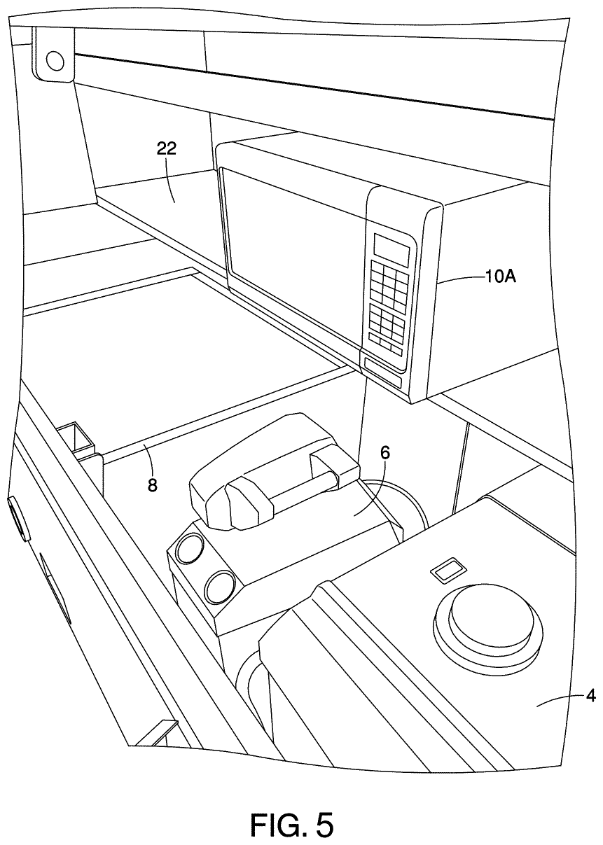

FIG. 6 is a perspective view of an interior of one example of a heating container of the system of FIG. 3.

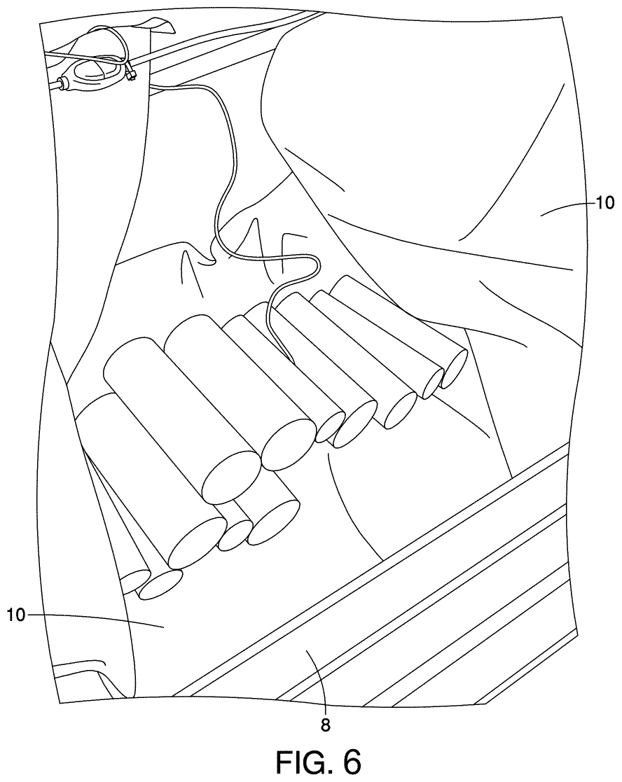

The drawings are not necessarily to scale and in some instances proportions may have been exaggerated in order to more clearly depict certain features.

### DETAILED DESCRIPTION

The description that follows and the embodiments described therein are provided by way of illustration of an example, or examples, of particular embodiments of the principles of various aspects of the present invention. These examples are provided for the purposes of explanation, and not of limitation, of those principles and of the invention in its various aspects.

The present invention relates to a skid-mounted, portable, liftable system for supporting use of the new pneumatic, hydraulic or conventional spray guns in remote, outdoor environments for painting or coating of both below ground and above grade applications. The present system provides an integrated, smart system of all the elements needed to utilize pneumatic, hydraulic or conventional spray guns for a remote spray painting or coating operation. The system and can be loaded on the back of any type of truck or transport device, hoisted by a crane or helicopter, or dragged on skids to remote locations and comprises its own compressed air, heating and power sources. Alternatively, the system can be built as a permanent unit fixed to a bed of any type of truck.

With reference to the attached Figures, the present system 2 is self-contained and comprises a power source 4, preferably a generator, to power the various elements of the system 2. The generator 4 can optionally also provide electrical power to any other painting or coating devices nearby that require power and are compatible with the generator's power output. The system 2 also comprises a compressor 6 to supply compressed air via one or more lines to the inlets of one or more spray guns. The compressor 6 is preferably sized to supply compressed air to more than one spray gun over a range of lengths of spray line distances. It is also possible to have more than one compressor 6 to provide compressed air capacity as needed. While the compressor 6 can handle most spray line lengths, since the present system 2 is portable and compact, it can also be positioned much closer to substrates being painted or coated, than previous systems.

An insulated heating container 8 can store multiple cartridges containing the painting or coating components. Pails or cartridges for any number of types of painting or coating components for any number of types of painting or coating jobs can be stored in the heating container and kept at a desired temperature, thereby making the system useable for multiple jobs either at the same time or short succession.

In one preferred embodiment, the heating container 8 can be heated by means of one or more heating blankets 10 within the container 8, preferably lining the container 8, to heat cartridges to a predetermined temperature. The heating blankets 10 are preferably electrical and can be powered by the generator 4. The heating blankets 10 are more preferably connected to a thermostat 12 and control panel 20 on an external surface of the system 2 to monitor and control the temperature inside the heating container 8. It is also possible to heat the heating container 8 by other means such as an electrical heater, heating coils of heated fluid, electrical heating coils and further such means as would be understood by a person of skill in the art.

The control panel 20 of the present system 2 allows a single operator to control temperature, compressor 6 operation, and to turn the system 2 on or off. Remote operation of the system 2 is also possible by means of an application on any computer, tablet or smart phone, by which an operator can turn the system 2 on or off, and monitor and set the temperature of the heating container 8. In this way, the system 2 can be turned on and the cartridges heated or preheated before an operator arrives at site, so that the painting or coating operation can be conducted as soon as the operator arrives. Temperature monitoring of the cartridges of painting or coating components also allows for data logging to provide a record that painting and coating cartridges met temperature specifications when used. A GPS tracker can also be included on the system 2 so that location of the system 2 can be centrally tracked and monitored.

A number of preferable features can also be provided in the system 2. In one example, the system 2 is housed in a transportable case 14 that can be fitted with casters, wheels, lifting lugs, lifting eyes, skids etc., for ease of transport. As mentioned previously, the case 14 can be loaded on the back of any truck and transported to any remote work or plant site. In cases where road access is not available to a location requiring painting or coating, the case 14 can be lifted by helicopter and transported with an operator to the painting or coating site. Only one operator is required to operate this system 2.

One or more walls 24 of the case 14 are provided with one or more panel accesses 16 to one or more components of the system 2. Further preferably the compressor 6 and generator 4 can be mounted on a sliding shelf 18 on which they can be easily removed or replaced in case repair or replacement is required.

The walls 24 of the case 14 can also include one or more external vents 26 to provide cooling to the compressor 6, generator 4 and other components to prevent overheating or fire hazard. These external vents 26 are illustrated along the sides of the case 14, although other locations of the external vents are also possible and encompassed by the scope of the present disclosure. A blower 28 may also be provided to promote air circulation through compartments of the system case containing the compressor 6, generator 4, or other components.

A number of back-up components can also be stored in the case 14, such as a 110 volt power connection 4a to provide power should the generator 4 fail, an airline hook up 6a to an external air compressor, should the system's compressor 6 fail, and a back-up heater 10a should the heating blanket 10 fail or not produce enough heat. In one example the back-up heater 10a can be a microwave stored in the case and powered either by the generator 4 or by an optional power connection. Storage 22 for one or more spray guns is also optionally provided.

In operation, the present system 2 can be transported to a site for substrate painting or coating. As a portable system 2, the system can be transported on any truck or transport device and be accommodated in smaller access locations. The heating container 8 can be loaded with multiple cartridges of different types for different applications and for use in different spray guns. Heating of the heating container 8 can be initiated and maintained throughout transportation and at site, powered by the system's generator 4. Once at site, a single operator can check and adjust temperature inside the heating container 8 via the control panel 20. Spray guns, stored in the case 14 can be selected by the operator and connected to the air compressor 6. As mentioned, more than one spray gun is capable for use simultaneously with the present system 2. Cartridges of the desired painting or coating components can then be loaded in the spray gun. No component lines, heating lines, pumps or insulated hose are required. The operator can now proceed with a painting or coating operation. In addition to painting or coating field welds, smaller repair jobs can be painted or coated using the present system, eliminating the need for manual mixing and brush on application of paint or coatings.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A portable system for use with one or more painting or coating spray guns, said system comprising:
a. a system case, said case being liftable, towable and transportable by helicopter or truck; said case containing:
i. storage for one or more coating or paint cartridges, said storage being heatable to maintain cartridges at a predetermined temperature;
ii. an independent power source; and
iii. an independent source of compressed air;
wherein said system is operable by a single user and usable in connection with one or more painting or coating spray guns for remote site painting and coating operations.

2. The system of claim 1, wherein the system case further comprises a control panel operable by a single user to power the system, control and monitor temperature and control and monitor operation of the source of compressed air.

3. The system of claim 1, wherein the system is remotely operable to turn the system on or off, monitor and set the temperature of the storage and control operation of the source of compressed air.

4. The system of claim 1, further comprising a GPS tracker for remote tracking of the location of the system from a central location.

5. The system of claim 1, wherein power source is a generator that is further operable to provide electrical power to further painting or coating devices nearby.

6. The system of claim 1, wherein the source of compressed air is an air compressor sized to supply compressed air to the one or more spray guns.

7. The system of claim 6, wherein the air compressor is sized to provide compressed air over a range of lengths of spray line distances.

8. The system of claim 1, wherein the system is portable and positionable proximal to substrates being painted or coated.

9. The system of claim 1 wherein the storage is an insulated heating container having capacity to store multiple paint or coating cartridges.

10. The system of claim 9, wherein the insulated heating container further has capacity to store one or more pails of one or more types of painting or coating components.

11. The system of claim 9, wherein the insulated, heating container is heated by means of one or more heating blankets that form a lining within the container.

12. The system of claim 11, wherein the one or more heating blankets are electrical and are powerable by the independent power source.

13. The system of claim 1, wherein the system case comprise any one or more of casters, wheels, lifting lugs and skids for ease of transport.

14. The system of claim 1, wherein the system case comprises one or more sliding shelves for supporting any one or more components of the system and for allowing ease of removal or replacement of said components.

15. The system of claim 1, wherein one or more walls of said system case comprise one or more external vents to provide venting and cooling to any one or more of the components of the system case.

16. A method of performing painting and coating operations in a remote site, said method comprising the steps of:
b. transporting a case by means of truck, helicopter or towing to the remote site;
c. providing within said case: storage for one or more coating or paint cartridges, said storage being heatable to maintain cartridges at a predetermined temperature; an independent power source; and an independent source of compressed air;
d. connecting one or more spray guns to the source of compressed air and charging the one or more spray guns with one or more cartridges; and
e. coating with the one or more spray guns, a surface to be coated.

17. The method of claim 16, further comprising heating of the storage throughout transportation such that coating or paint is at a predetermined temperature when the case reaches the remote site.

18. The method of claim 16, further comprising remotely turning the system on or off, monitoring and setting temperature of the storage and remotely operating source of compressed air.

19. The method of claim 16, further comprising, monitoring temperature of the paint or coating cartridges and logging temperature data to provide a record paint and coating cartridges temperatures at use.
